(19) United States
(12) Patent Application Publication
(10) Pub. No.: US 2009/0237671 A1
(43) Pub. Date: Sep. 24, 2009

(54) ANALYSIS OF OPTICAL EFFECTS ON STORAGE MEDIUM

(75) Inventor: Coen Adrianus Verschuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,540

(22) PCT Filed: Dec. 14, 2005
(86) PCT No.: PCT/IB05/54235

§ 371 Date: Jun. 13, 2007

(30) Foreign Application Priority Data
Dec. 20, 2004 (EP) 04106742.2

(51) Int. Cl. G01N 21/55; G11B 7/00

(52) U.S. Cl. 356/448; 369/53.11; G9B/7

(57) ABSTRACT

A method of analyzing the quality of optical effects on an optical recording medium as well as applications of the method in connection with optimizing a write strategy and analyzing the write quality for an optical recording medium are disclosed. The method comprising the steps of determining waveforms of a measured (61) and a nominal (60) optical signal, and calculating an amplitude-difference parameter from a difference (62-65) in the measured and nominal waveforms. A quality measure of the optical effects can thereby be determined from the amplitude-difference parameter. The applications of the method include, but are not limited to: a device for reading optical effects from an optical storage medium with means for determining the an amplitude-difference parameter, an optical recording apparatus with means for adjusting the power level and/or level duration in a write strategy and an IC for controlling an optical storage apparatus.

The invention relates to a method for analyzing the quality of optical effects on an optical recording medium and to applications of the method.

The technology of reading and writing information to and from optical disks has made remarkable advancements in recent years. With the advancement of the technology various types of recording formats and corresponding media has emerged. On the market today there exists inter alia, read-only media, i.e. ROM-disks such as for music play-back, write-once optical disks, where data may be written only once but read many times, and rewritable disks for recording and erasing data multiple times. These three different formats each have a raison d'être, and each have strengths and weaknesses. Common for the three types is a wish of increasing the data capacity so that more data may be present or provided onto a single disk.

There are, however, a number of limiting factors for the size of the data capacity. One important factor is the size of the optical spot, which on high-capacity disks becomes almost as large as the size of the smallest optical effects on the disk. In this limit, information of more than one single bit may be detected by the optical spot resulting in inter-symbol interference (ISI).

In the Blu-ray disk (BD) format it is possible to analyze the time between slicer crossing for capacities up to 27 GB, and thereby determine the lengths of the optical effects. But for capacities above 27 GB it is no longer possible to unambiguously determine the slicer level, and also the well-known jitter analysis in connection with optimum power calibration (OPC) for adjusting the write strategy in a recording mode, is not possible.

The inventors of the present invention have appreciated that currently no solution exists to analyze the quality of the written effects on an optical medium for capacities in the 30-37 GB range, such a solution is of benefit, and the inventors have in consequence devised the present invention.

The present invention seeks to provide improved means for analyzing the quality of written effects on an optical medium. Preferably, the invention alleviates or mitigates one or more of the above or other disadvantages singly or in any combination.

Accordingly there is provided, in a first aspect, a method for analyzing the quality of optical effects on an optical recording medium, the method comprising the steps of:

a) determining a waveform of a measured optical signal from the optical recording medium,
b) determining a waveform of a nominal signal, the nominal signal being calculated by means of an optical channel model,
c) calculating an amplitude-difference parameter, the amplitude-difference parameter being based on an amplitude difference in the measured waveform and the nominal waveform, wherein a quality measure of the optical effects is determined from the amplitude-difference parameter.

A measured optical signal, such as a measured optical signal from a read-only, write-once, rewritable, etc. CD-type disk, DVD-type disk, BD-type disk etc., is a modulated signal wherein the modulation represents the binary data present on the disk. On the disk information is stored in a pattern of optical effects, e.g. referred to as marks. A typical encoding of the information is the runlength encoding, where information is stored in optical effects and spaces between the optical effects, as wells as the lengths of the optical effects and the spaces. The bit pattern on a disk may in the runlength encoding be represented by a timing sequence of transition shifts between spaces and optical effects. The bit type (i.e. optical effect or space) and bit length may be deduced from the type of transition shift and the timing between the transition shifts.

The calculated model signal may mathematically be represented by a linear optical model such as the Braat-Hopkins model.

The amplitude-difference parameter is based on an amplitude difference between the measured waveform and the nominal or calculated waveform. The amplitude-difference parameter may be a simple subtraction, however it may also be a more complex parameter, such as a width or mean of a distribution of differences, a mathematical operation may be conducted in order to obtain the parameters, etc.

It is an advantage to determine a quality measure of the optical effects from the amplitude-difference parameter, since such a measure is indicative of the quality of the written optical effects which may be used even for such data capacities as capacities above 30 GB, such as in the range 30-37 GB.

A histogram of an amplitude-difference parameter may be provided, and wherein the quality measure is determined from the width and centering of the histogram. Thus the amplitude difference may be determined as a function of a given feature, and a histogram of the distribution of the feature may be provided. The width of the distribution and/or the centering, i.e. whether or not an off-set is present may be used as quality measures.

It is an advantage to provide a histogram of an amplitude-difference parameter since such a histogram may fast provide insight into the overall quality of the written effects.

The optical signal may comprise first sections reflected from first regions with first widths, and second sections reflected from second regions with second widths, wherein transitions from the first to the second regions are labeled leading edges indexed by the second and first widths (also referred to as lengths or runlength) and transitions from the second regions to the first regions are labeled trailing edges indexed by the first and second widths, wherein the amplitude-difference parameter is obtained around leading and/or trailing edges.

The optical signal thus comprises first and second sections corresponding to whether the light was reflected from first or second regions. The first and second regions may be identified as spaces and marks respectively in a phase-change type disk or write-once type disk, as pits and lands in a ROM-type disk, etc.

The amplitude-difference parameter may be obtained for a specific type of transition, i.e. as a function of a given transition. The amplitude-difference parameter may even be determined as a function of the width of the region prior to a specific transition and/or the width of the following region. For example, the amplitude-difference parameter may be determined as a transition from a mark to a space, or from a mark of a specific length to a space of any given length, or even as a mark of a specific length to a space of a specific length.

It is an advantage to determine the amplitude difference in this manner, since it may provide more detailed insight into the systematic behavior of the various combinations present in the pattern of the optical effects on a disk, and thereby directly reveal a possible systematic error in the positioning or lengths of the various pattern combinations.

The amplitude-difference parameter may be obtained from a change of the amplitude difference or sum across a transition. Thus a mathematical operation may be performed onto the amplitude different in order to provide an amplitude-difference parameter. The difference or sum across a transition may provide even further insight into the quality and possible errors of the optical effects.

According to a second aspect of the present invention, a device is provided for reading optical effects from an optical storage medium comprising:

a radiation source for emitting a radiation beam onto an optical storage medium,

a read unit for reading the recorded effects,

means for determining the amplitude-difference parameter as determined by the method according to the first aspect of the present invention.

Such a device may be provided in connection with or as a part of an optical storage apparatus for analyzing the quality of optical effects. The device may also be provided either as a standalone analyzer device or as a part of an analyzer device.

According to a third aspect of the present invention, an optical recording apparatus is provided, the apparatus comprising:

a radiation source for emitting a radiation beam having a controllable value of a write power level for recording optical effects on the recording medium,

a read unit for reading the recorded effects,

means adjusting the power level and/or level duration in a write strategy according to an amplitude-difference parameter as determined by the method of the first aspect of the invention.

Such a device may be provided in connection with or as a part of an optical recording apparatus capable of analyzing the quality of optical effects e.g. in connection with an optimization procedure of the written optical effects before a recording operation.

According to a fourth aspect of the present invention is provided an integrated circuit (IC) for determining an amplitude-difference parameter, the IC being adapted to drive an optical storage apparatus so as to measure an amplitude-difference parameter as determined by the method of the first aspect of the invention. The IC may be incorporated in a device or apparatus according to the second or third aspect of the present invention.

According to a fifth aspect, the present invention relates to optical effects on an optical storage medium being provided using a write parameter determined from an amplitude-difference parameter in a measured waveform and a nominal waveform, the amplitude-difference parameter being determined by the method according to the first aspect.

In the simplest method optical effects are provided to an optical medium by turning the laser on at a predetermined power lever for a predetermined duration depending upon the desired length of optical effect, and turning the laser off between the optical effects for a duration corresponding to a desired length of the space. However, the write strategy may be more complex than this, for example in connection with the direct overwrite method

According to a second aspect of the present invention, a device is provided for reading optical effects from an optical storage medium comprising:

a radiation source for emitting a radiation beam onto an optical storage medium,

a read unit for reading the recorded effects,

means for determining the amplitude-difference parameter as determined by the method according to the first aspect of the present invention.

Such a device may be provided in connection with or as a part of an optical storage apparatus for analyzing the quality of optical effects. The device may also be provided either as a standalone analyzer device or as a part of an analyzer device.

According to a third aspect of the present invention, an optical recording apparatus is provided as defined in claimed 11.

Such a device may be provided in connection with or as a part of an optical recording apparatus capable of analyzing the quality of optical effects e.g. in connection with an optimization procedure of the written optical effects before a recording operation.

According to a fourth aspect of the present invention is provided an integrated circuit (IC) for determining an amplitude-difference parameter, the IC being adapted to drive an optical storage apparatus so as to measure an amplitude-difference parameter as determined by the method of the first aspect of the invention. The IC may be incorporated in a device or apparatus according to the second or third aspect of the present invention.

In the simplest method optical effects are provided to an optical medium by turning the laser on at a predetermined power lever for a predetermined duration depending upon the desired length of optical effect, and turning the laser off between the optical effects for a duration corresponding to a desired length of the space. However, the write strategy may be more complex than this, for example in connection with the direct overwrite method (DOW) used in connection with phase-change type media. In general the optical effects are written by means of laser pulses with a pulse shape characterized by a number of write parameters, this is referred to as a write strategy. Typically, the write strategy may be described by a number of write parameters such as commands to turn laser power on and off, setting the laser power to as specific level, maintaining the laser power for a given duration, etc. It is important, and sometimes even necessary, to calibrate, i.e. optimize, the write strategy before writing data on a new optical recordable medium.

The write strategy that describes a desired write pulse may include one or more write parameters. The write strategy may depend upon the desired specific optical effect, i.e. the length of the effect and the write parameters in a write pulse for writing a specific optical effect. Standard write strategies may exist, categorized according to the resulting length of the written optical effect, i.e. I2-strategies for writing I2-marks, I3-strategies for writing I3-marks, etc. The write strategies, i.e. the write parameters included in a specific write strategy, may be optimized in connection with a optimization routine where optical effects are provided to an optical storage medium, an amplitude parameter according to the first aspect of the invention is determined, and the write strategy is adapted, i.e. by changing one or more write parameter. The routine may be repeated until a satisfactory amplitude-difference parameter is obtained.

According to a sixth aspect, the invention relates to a computer readable code for determining an amplitude-difference parameter, the code being adapted to determine an amplitude-difference parameter according the method of the first aspect.

The various aspects of the invention may be combined and coupled in any way possible within the scope of the invention.

These and other aspects, features and/or advantages of the invention will be apparent from and elucidated with reference to the embodiments described hereinafter. Embodiments of the invention will be described, by way of example only, with reference to the drawings, in which

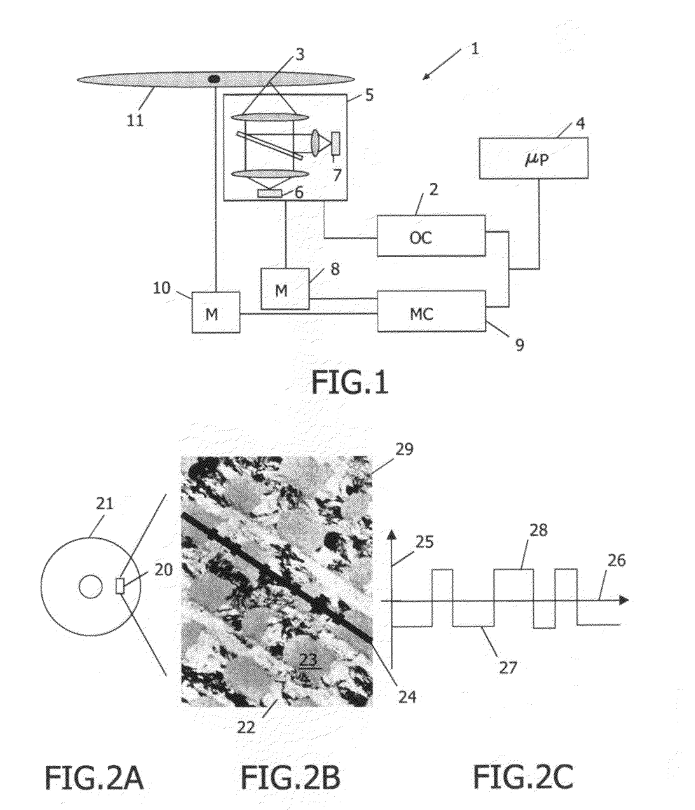

FIG. 1 schematically illustrates an optical recording apparatus capable of reading and/or writing information from and/or to an optical storage medium,

FIG. 2 schematically illustrates optical effects on a Blu Ray disk,

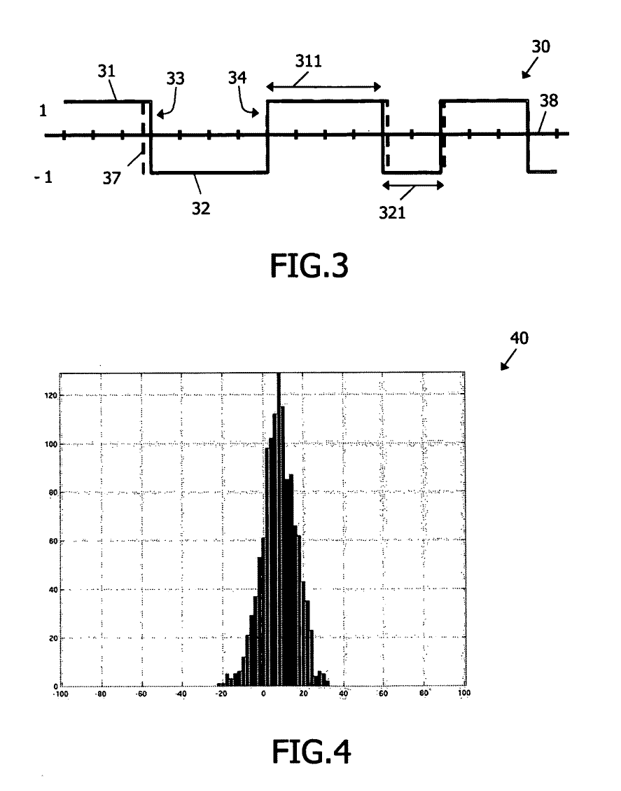

FIG. 3 schematically illustrates a series of channel bits from an optical signal,

FIG. 4 shows a histogram of the transitions from a random space runlength to a 3T mark runlength,

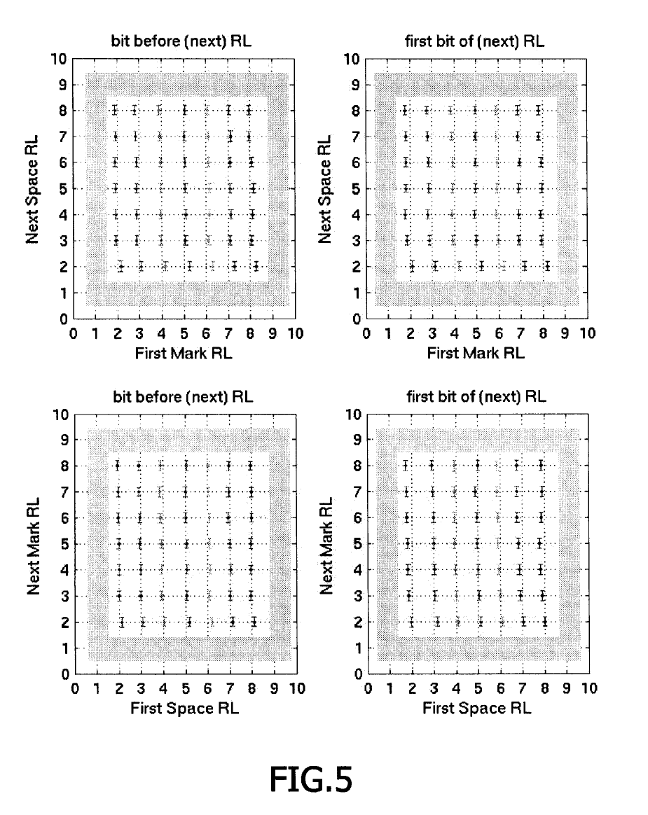

FIG. 5 shows matrix graphs for transitions from a mark runlength to a space runlength and for transitions from a space runlength to a mark runlength,

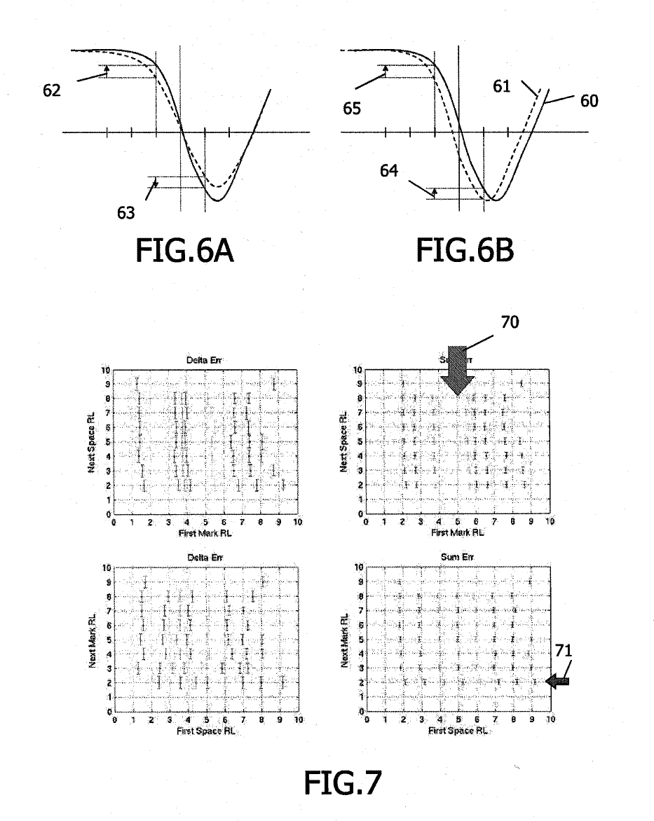

FIG. 6 schematically illustrates the difference and sum of the amplitude differences across a single transition,

FIG. 7 shows matrix distributions of amplitude differences across transitions obtained using a first write strategy,

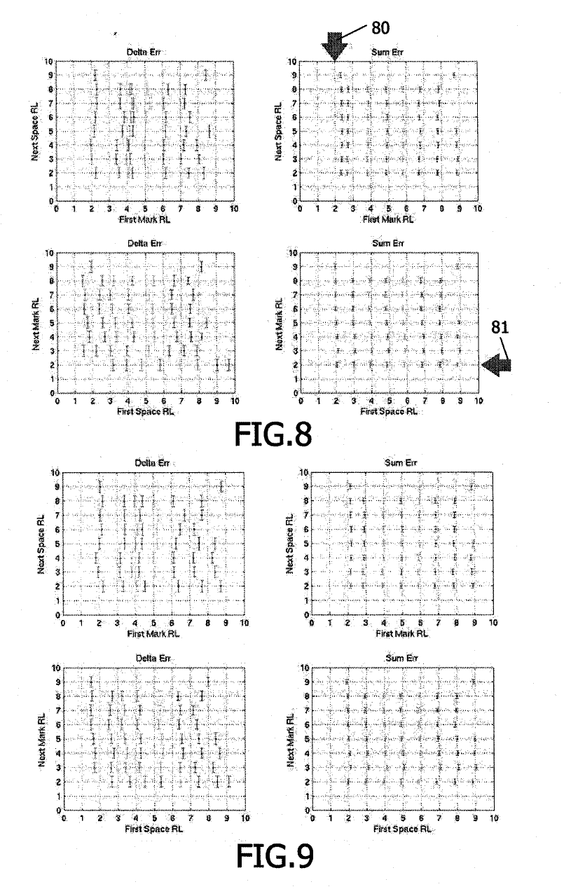

FIG. 8 shows matrix distributions of amplitude differences across transitions obtained using a second write strategy, and

FIG. 9 shows matrix distributions of amplitude differences across transitions obtained using a third write strategy.

An optical storage apparatus 1 capable of reading and/or writing information from and/or to an optical storage medium is schematically illustrated in FIG. 1.

A real optical storage apparatus comprises a large number of elements with various functions, only a few are illustrated here. Motor means 9,10 are present for rotating the disk 11 and controlling the motion of an optical pickup unit 5, so that an optical spot 3 can be focused and positioned at a desired location on the disk. The optical pickup unit includes a laser 6 for emitting a laser beam which may be focused on the disk by means of a number of optical elements. The focused laser light may in a recording mode be sufficiently intense so that a physical change may be provided to the optical disk, i.e. optical effects are provided onto the disk. Alternatively, in a reading mode the laser power is insufficient to induce a physical change and the reflected laser light detected by a photodetector 7 for reading the optical effects on the disk.

In the present invention the measured optical signal from the optical recording medium may be the signal as seen by the photodetector 7, the signal may either by a dedicated unit (not shown) or by processing means 4 be transformed into a form which is suitable for further processing.

The control of the storage apparatus may be done either by hardware implementation, such as illustrated by the motor control 9 and optics control 2. In addition, also microprocessor control means 4 is present. The microprocessor control means (e.g. integrated circuit (IC) means) contain both hardwired processing means and software processing means, so that e.g. a user, such as by means of a high-level control software, may influence the operation of the apparatus. Examples of high-level control settings include control of the pulse shape in a write strategy of the emitted laser power in recording mode.

In FIG. 2 is an example of optical effects on a Blu Ray disk (BD) provided. FIG. 2B illustrates a blow-up 29 of a region 20 on a BD disk 21 schematically illustrated in FIG. 2A. The blown-up region shows both optical effects 23 and regions 22 between the optical effects. The effects are aligned along a track spiraling from the center and outwards, a section 24 of a track is illustrated. Light reflected from the track section 24 is illustrated schematically in FIG. 2C, where the intensity of the reflected light is illustrated along the vertical axis 25 as a function of the position along the horizontal axis 26, i.e. as a function of the time. The optical effects 23 are often referred to as marks 27, whereas the region 22 in between the marks often are referred to as spaces 28. In a phase-change type disk, the marks 23,27 are amorphous regions with low reflectivity, whereas the spaces 22,28 are crystalline regions with high reflectivity.

In optical recording, data is stored in marks 27 and spaces 28 of different runlengths, i.e. different widths (lengths). Important for the optimal performance of a given disk is that all marks and spaces are integer step like. In BD, the shortest effects are 2 times the channel bit length (=unit length), also called T2's. The longest effects are 9 times the channel bit length and are called T9's. When the lengths of the marks and spaces are not exactly a multiple of the channel bit length, this will be seen as deviations from the optimal situation and will result in a deteriorated bit detection performance.

FIG. 3 illustrates a series of channel bits from an optical signal. The series of channel bits 30 comprising first sections 31 corresponding to light reflected from first regions with first widths 311, being spaces or high reflectivity regions, and second sections 32 corresponding to light reflected from second regions with second widths 321, being marks or low intensity regions. The transitions from the first to the second regions are labeled leading edges 33, and transitions from the second regions to the first regions are labeled trailing edges 34.

On a real disk, the transitions from a high reflectivity (space) to low reflectivity (mark) are not always on the right position. Some are too much to the left (early in time=negative per definition) and some too much to the right (too late=positive). This is illustrated by the dotted lines 37 which indicate the measured edge position. In the figure a time axis 38 is illustrated as a horizontal axis, the time axis being discretized with so-called 1T (=1 channel bit) resolution. For an ideal signal, the transitions should lie on a 1T mark. In the following embodiments of implementations of the present invention are described. Thus embodiments of implementing a method for analyzing the quality of optical effects on an optical recording medium.

At data capacities where ISI is important, information is stored in the signal amplitudes rather than in the location of the zero-crossings. Therefore, the differences in amplitude between the sampled values of the readout waveform and the nominal values, as e.g. obtained from a suitable channel model (such a model can be a fixed, linear, truncated (partial) response or e.g. an adaptive model taking non-linearities into account [see e.g. R Otte and W. Coene, “Evaluation of adaptive PRML/Viterbi bit detection for DVD and beyond”, IEEE Trans. Cons. Electr. 46, pp. 1018-1020, 2000]) may provide a quality measure of the optical effects present on a medium. In particular, amplitude differences around runlength transitions contain valuable information for write strategy optimization.

The distribution of amplitude differences, for example at the first bit of each runlength transition, in a properly working system will be a Gaussian-like distribution with a mean value of zero (i.e. on average no amplitude offset is present), and a certain width which corresponds to the amplitude ‘jitter’. In an embodiment of the present invention can the distribution width be used as a quality measure, since the width should be as small as possible.

In FIG. 4 is a histogram 40 of the transitions from a random space runlength to a 3T mark runlength for a non-optimized 25 GB write strategy provided. Such a histogram for a specific type of transition is usually more narrow than the ‘overall’ distribution.

A histogram as illustrate in FIG. 4 may not provide detailed information about how to optimize a write strategy in order to improve the optical effect quality. However, it provides a fast and qualitative quality measure, e.g. by comparison with reference distributions obtained on media where the optical effects are optimal.

More detailed information may be obtained by looking at the distributions of specific transitions only.

To include the influence of previous or following runlengths in the recording and/or the readout process, it is better to evaluate individual distributions being specified by (at least) a first runlength and a consecutive next runlength. This can be depicted in a matrix-like graph as illustrated in FIG. 5, showing the first run length on the x-axis and the second runlength on the y-axis. The mean and standard deviation of the different individual distributions are represented by a horizontal offset from the corresponding grid position, and an error bar, respectively.

In FIG. 5, such matrix-like graphs are shown for transitions from a mark runlength to a space runlength (top), and for transitions from a space runlength to a mark runlength (bottom). The graphs on the left depict the distributions for the last bit of the first runlength (i.e. the ‘bit before the next RL’), whereas the graphs on the right show the distributions for the first bit of the next runlength. In other words, left corresponds to the bit before (to the ‘left’ of) the transition, right corresponds to the bit directly after (to the ‘right’ of) the transition between the runlengths. For an optimized write strategy and a good channel model, the offsets from the grid positions and the error bars (the standard deviations of the distributions) are small. Graphs as illustrated in FIG. 5 thus provide a quality measure of each of the transition types, e.g. by comparing the individual mean values and standard deviations to reference values.

Even further insight may be obtained by analyzing the distributions of the change (delta) and/or the sum of the amplitude differences across a specific transition. This is illustrated schematically in FIG. 6 for a single transition. The arrows 62-65 indicate the amplitude difference between the reference waveform (solid) 60 and the actual waveform (dashed) 61 before and after the transition. The reference waveform would in a situation of use be calculated, whereas the actual waveform would be measured.

In FIG. 6A a situation is illustrated where a deviation in the slope of the transition e.g. due to incomplete writing of a small runlength, etc. will lead to a change in amplitude differences across the transition, i.e. a non-zero change or delta (e.g. arrow before minus arrow after). In FIG. 6B on the other hand is illustrated that the sum of the amplitude differences across the transition corresponds to a shift of the transition. In practice, such a shift can be due to an incorrect (sub-optimal) laser pulse position or power in the write strategy for that particular transition. The sign (as indicated by the direction of the arrows 62-65) and amplitude of the shift can therefore be used to specifically correct the write strategy. As discussed in connection with FIG. 5 one may look at the distributions of the deltas and sums for the various transitions between runlengths in a matrix-like form to gain insight into systematic errors.

To illustrate the application of the approach discussed in connection with FIGS. 7-9 for write strategy optimization, the well-understood 25 GB Blu-ray Disk system has been used as an example. Because this capacity is relatively low, transition slope effects are not so important here, and the focus will be on the transition shifts (right part of the figures containing sum distributions). This approach is equally well suited for much higher capacities where no alternative evaluation methods exist. In the following figures, the offset scale has been magnified for clarity.

The FIGS. 7-9 each illustrates four graphs, the upper two graphs illustrate distributions between marks and the following space, for differences across the transition (left) and for the sum across the transition (right). The lower two graphs illustrate distributions between a space and the following mark for differences across the transition (left) and for the sum across the transition (right).

FIG. 7 shows the result where a standard write strategy has been modified such that the 5T mark's trailing edge is shifted backwards over 2/12 of the channel bit clock (erase pulse starts 2/12 earlier). For this capacity, jitter can be measured for the leading and trailing edges. The respective jitter values are 5.25% and 9.75% as a result of the applied shift. This shift causes all following space runlengths to be longer than normal. Indeed, this is clearly visible in the top-right sum graph: as indicated by the arrow 70, all ‘next space RL’ after a ‘first mark RL’ of 5 exhibit a large positive shift. (For the other ‘first mark RL’ smaller shifts are also observed, these are due to effects from the slicer, which tries to keep the overall offset as close as possible to zero). It is seen that, the bottom-right graph, which focuses on the mark's leading edges (or the space trailing edges), is not affected by the applied shift. In this bottom-right graph in FIG. 7 it is also seen that for the ‘next mark RL’=2, there is a systematic positive shift 71, i.e. the 2T mark's leading edge is too far to the right.

In FIG. 8 the systematic positive shift has been tried corrected by shifting the complete 2T mark (both leading and trailing edge) over 1/12 to the left. The leading edge position has indeed improved considerably (bottom-right graph, arrow 81), but the trailing edge position has clearly deteriorated (top-right graph, arrow 80). A much better result is obtained if only the 2T mark's leading edges are shifted (i.e. the 2T length is also increased), as suggested by FIG. 7. This result is shown in FIG. 9.

Although the present invention has been described in connection with preferred embodiments, it is not intended to be limited to the specific form set forth herein. Rather, the scope of the present invention is limited only by the accompanying claims.

In this section, certain specific details of the disclosed embodiment such as method steps, specific mathematical models, data representations, specific parameters etc., are set forth for purposes of explanation rather than limitation, so as to provide a clear and thorough understanding of the present invention. However, it should be understood readily by those skilled in this an, that the present invention may be practiced in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

Reference signs are included in the claims, however the inclusion of the reference signs is only for clarity reasons and should not be construed as limiting the scope of the claims.

1. Method for analyzing the quality of optical effects (23) on an optical recording medium (11), the method comprising the steps of:
a) determining a waveform (61) of a measured optical signal from the optical recording medium,
b) determining a waveform (60) of a nominal signal, the nominal signal being calculated by means of an optical channel model,
c) calculating an amplitude-difference parameter, the amplitude-difference parameter being based on an amplitude difference in the measured waveform and the nominal waveform, wherein a quality measure of the optical effects is determined from the amplitude-difference parameter.

2. Method according to claim 1, wherein a histogram (40) of an amplitude-difference parameter is provided, and wherein the quality measure is determined from the width and centering of the histogram.

3. Method according to claim 1, wherein the optical signal comprising first sections (28,31) reflected from first regions (22) with first widths (311), and second sections (27,32) reflected from second regions (23) with second widths (321), wherein transitions from the first to the second regions are labeled leading edges (33) indexed by the second and first widths and transitions from the second regions to the first regions are labeled trailing edges (34) indexed by the first and second widths, wherein the amplitude-difference parameter is obtained around leading and/or trailing edges.

4. Method according to claim 3, wherein the amplitude-difference parameter is obtained for a specific type of transition.

5. Method according to claim 3, wherein the amplitude-difference parameter is determined as a function of the width of the region prior to a specific transition and/or the width of the following region.

6. Method according to claim 3, wherein the amplitude-difference parameter is obtained from a change (62,63) of the amplitude difference across a transition.

7. Method according to claim 3, wherein the amplitude-difference parameter is obtained from a sum (64,65) of the amplitude difference across a transition.

8. Device for reading optical effects (23) from an optical storage medium (11) comprising:
a radiation source (6) for emitting a radiation beam onto an optical storage medium,
a read unit (7) for reading the recorded effects,
means for determining the amplitude-difference parameter as determined by the method of claim 1.

9. Optical recording apparatus (1) comprising:
a radiation source (6) for emitting a radiation beam having a controllable value of a write power level for recording optical effects (23) on the recording medium (11),
a read unit (7) for reading the recorded effects,
means adjusting the power level and/or level duration in a write strategy according to an amplitude-difference parameter as determined by the method of claim 1.

10. Integrated circuit (IC) for determining an amplitude-difference parameter, the IC being adapted to drive an optical storage apparatus so as to measure an amplitude-difference parameter as determined by the method of claim 1.

11. Optical effects (23) on an optical storage medium being provided using a write parameter determined from an amplitude-difference parameter in a measured waveform (61) and a nominal waveform (60), the amplitude-difference parameter being determined from a method according to claim 1.

12. Computer readable code for determining an amplitude-difference parameter, the code being adapted to determine an amplitude-difference parameter according the method of claim 1.

13. Use of an amplitude-difference parameter determined from an amplitude-difference parameter determined between a measured waveform and a nominal waveform for setting an optimum value of a write parameter in an optical recording apparatus.
